(19) United States
(12) Patent Application Publication
(10) Pub. No.: US 2009/0216645 A1
(43) Pub. Date: Aug. 27, 2009

(54) SYSTEM AND METHOD FOR GENERATING LEADS FOR THE SALE OF GOODS AND SERVICES

(75) Inventor: Steven Robert Oleen, Mansfield, OH (US)

Correspondence Address: Fay Sharpe LLP, 1228 Euclid Avenue, 5th Floor, The Halle Building, Cleveland, OH, 44115, US

(73) Assignee: What's In It For Me.Com LLC

(21) Appl. No.: 12/390,854

(22) Filed: Feb. 23, 2009

Related U.S. Application Data
(60) Provisional application No. 61/030,394, filed on Feb. 21, 2008.

(51) Int. Cl. G06Q 30/00; G06Q 10/00; G06F 3/048

(52) U.S. Cl. 705/14; 705/26; 715/760

(57) ABSTRACT

As set forth herein, a computer program embodied on a computer readable medium creates a web interface to facilitate a sales transaction between a vendor and a customer via a sales lead system. A web interface source code segment facilitates the presentation of content to a user that accesses the web interface and allows the reception of data provided by the user to interface with the sales lead system. A lead source module allows a lead source to add lead information to the sales lead system, the lead source module is configured to receive lead source information related to an imminent purchase of at least one of a good and a service by a prospect, and a name of the prospect. A vendor module allows one or more vendors to access one or more leads and/or interface with the prospect to receive additional information related to the lead, wherein the one or more vendors are not provided with information to identify the lead source.

### TECHNICAL FIELD

The disclosed embodiments are generally directed to the consummation of sales transactions in the marketplace. They are more specifically related to systems and methods to facilitate the exchange of information related to imminent sales events. This information exchange can be particularly beneficial to parties otherwise unknown to each other. However, it is to be appreciated that the present exemplary embodiments are also amenable to other like applications.

### BACKGROUND

Every day, millions of sales transactions take place across the United States and throughout the world. A large quantity of these sales transactions are completed between business/residential customers and vendors with a dedicated inside or outside sales department. In other words, sales transactions that take place outside of the traditional retail store environment. Examples of products sold during these types of transactions include business products such as, for example, telephone systems, copy machines, computers, office machines, software, office furniture, and the like. Other examples can be found in the building and construction trades such as, for example, electrical, plumbing, HVAC, steel erection, masonry, building construction, and the like. Further examples can also be found in service industries such as, for example, landscaping and lawn care, IT services, office cleaning services, facilities and machinery maintenance, and the like. The list is endless. Success or failure for these vendors is based on their ability to locate and make contact with prospective customers.

The normal sales cycle includes the steps of prospecting, approaching, interviewing, presenting, and closing. Prospecting is the first step for the sales person in identifying prospects (prospects) for any given product or service. Prospecting includes, but is not limited to, advertising, promotion, finder's fees, telemarketing calls, pre-approach letters, door-to-door canvassing. Prospecting is by far the most difficult, time consuming, and expensive portion of the sales process. The approach to the prospect with the intention of setting an appointment to meet and discuss a sales person's product or service is critical to the sales process going forward.

A salesperson's finesse, training, confidence and experience are critical in this phase of the sales process. The sales interview takes place during the first appointment and is a time when the prospect's wants, needs and, most importantly, “prime buying motives” are discovered. The interview is critical to fully understanding what is required to be the successful vendor. The presentation is the time when the sales person actually presents his/her product or service. Typically, the proposal or price quote is presented at this time and a close is attempted. The close is simply asking for the order. If all previous aspects of the sales process have been conducted thoroughly and professionally, the close is a natural extension and part of the relationship that has been created. If, however, prime buying motives have not been discovered, the close becomes more difficult and could result in a turning point in the sales process where the prospect begins to favor a competitor or a change in enthusiasm for your product or service.

The step of prospecting in the sales cycle is the most expensive and difficult to master and manage. A large amount of every vendor's budget is dedicated to prospecting and approaching prospects at a time that is conducive to starting the sales process. This cost of prospecting by sales people comprises a significant part of the selling price of any product or service, which is a part of the direct cost of sales. To improve the step of prospecting, many sales organizations provide incentives or finder's fees that are offered to people outside the vendor's organization, who provide information, tips and sales leads that result in a sale.

Most referral agencies, however, do not have complete or timely information. Additionally, most individuals will not risk offending their acquaintance, friend, or employer, by voluntarily taking part in their business when they have not been asked to participate. A large portion of the direct cost of sales is also spent on advertising efforts. Repetitious and full market advertising coverage is expensive and designed to help prospects think of a specific product and/or vendor when the purchase of a particular product or service is required.

Accordingly, for at least the above referenced deficiencies, there is a need for systems and methods to generate higher quality sales leads.

### BRIEF DESCRIPTION

In one aspect, a computer program embodied on a computer readable medium creates a web interface to facilitate a sales transaction between a vendor and a customer via a sales lead system. A web interface source code segment facilitates the presentation of content to a user that accesses the web interface and allows the reception of data provided by the user to interface with the sales lead system. A lead source module allows a lead source to add lead information to the sales lead system, the lead source module is configured to receive lead source information related to an imminent purchase of at least one of a good and a service by a prospect, and a name of the prospect. A vendor module allows one or more vendors to access one or more leads and/or interface with the prospect to receive additional information related to the lead, wherein the one or more vendors are not provided with information to identify the lead source.

In another aspect, a method is employed to facilitate a sales transaction between a vendor and a customer via a sales lead system. A lead is received from an anonymous lead source via an interface coupled to a network, the lead is related to an imminent purchase of at least one of a good and a service by a prospect, and a name of the prospect. Information related to one or more vendors is received via the interface coupled to the network, the one or more vendors sell goods and/or services, wherein the one or more vendors are able to interface with the prospect to receive additional information related to the lead. The lead is matched to at least one of the vendors via a server coupled to the network. A sales transaction consummated between the at least one vendor and the prospect is identified and a kickback is delivered to the lead source based at least in part upon the consummation of the sales transaction.

### BRIEF DESCRIPTION OF THE DRAWINGS

FIG. 1 illustrates a system to allow a lead source and a vendor to interface, in accordance with an exemplary embodiment.

FIG. 2 illustrates a registration component that allows a new member to register with the system, in accordance with an exemplary embodiment.

FIG. 3 illustrates an authentication component that allows existing users to access the system, in accordance with an exemplary embodiment.

FIG. 4 illustrates a general member module that allows undesignated users to interface with the system, in accordance with an exemplary embodiment.

FIGS. 5A, 5B and 5C illustrate a lead source module that allows a user to enter information relating to an impending purchase event, in accordance with an exemplary embodiment.

FIG. 6 illustrates a vendor module that allows a user to provide information related to goods or services they provide, in accordance with an exemplary embodiment.

FIG. 7 illustrates a customer interface module that allows a customer to provide information related to impending sales events and/or rate one or more vendors within the system, in accordance with an exemplary embodiment.

FIG. 8 illustrates administrative functionality of the system, in accordance with an exemplary embodiment.

FIG. 9 illustrates administrative functionality of the system, in accordance with an exemplary embodiment.

FIG. 10 illustrates an information center that provides specific information to system users, in accordance with an exemplary embodiment.

FIG. 11 illustrates an exemplary web interface, in accordance with an exemplary embodiment.

FIG. 12 illustrates an exemplary lead form, in accordance with an exemplary embodiment.

### DETAILED DESCRIPTION

The present invention is a system and method for generating sales leads. A website business or service provider has a website dedicated to sales lead generation for all types of selling organizations (vendor) unaffiliated with the service provider but registered with the website. Sales leads are generated and reported to the website by individuals with information about the potential purchase of any product or service (lead source) by any other individual, company, institution or government entity (customer). Individuals reporting sales leads to the service provider do not have to be directly involved in the purchase of any product or service, they simply need to have knowledge of the potential sale. For example, a neighbor who hears that another neighbor is looking for a roofer or a lawn care service, a secretary who hears that her employer is looking to replace their business telephone system or purchase new office furniture, or an acquaintance who mentions that they are in need of a new insurance company—all are excellent examples of bona-fide sales leads.

Everyone has “insider” knowledge about someone else's intention to buy something, and this information, however incomplete, is valuable to those who have products and services to sell (vendors). The system and method according to the present invention is designed to assist and encourage people to willingly and enthusiastically share that type of information with the service provider, whereupon the service provider will enthusiastically share the information with vendors who are willing to pay a nominal finder's fee for the information.

There is currently no known, national, forum, established for all product and service categories, where anyone can report someone else's intent to buy. This type of forum does not exist for two very simple yet important reasons. First, most people will not risk offending their acquaintance, friend, or employer, by voluntarily taking part in their business when they have not been asked to participate. Second, there is no advantage, other than the act of friendship if asked to participate, either material or financial, for a person to do so. It is these two challenges that if overcome, creates an entire new system and method of prospecting for sales organizations in all direct sales industries, regardless of product or service. The present invention addresses both these challenges and provides exactly that type of forum for everyone, providing they have access to the Internet.

According to the present invention, the service provider establishes a website that is an on-line sales lead generator that collects and distributes highly sought after and detailed customer specific information about prospective customers off any product or service. These sales leads are sent directly to a vendor's sales representative in the field, within their own sales territory in a timely fashion. This information is gathered from lead sources at a time when perspective customers are actively “in the market” with the stated or considered intent to purchase. The lead source obtains the information anytime anyone who is considering a purchase mentions it to them. Any individual registered with the website and having specific knowledge of any other individual or company's intent to purchase any product or service is encouraged to confidentially and with assurance of anonymity, register that prospective customer with the website. Preferably, the customer never knows the identity of the lead source, the lead source never knows the identity of the vendor, and the vendor never knows the identity of the lead source.

The website serves as a protective wall between these parties to assure anonymity, wherein security measures such as, for example, encryption techniques are employed to insure confidentiality. Preferably the website is encrypted so that each character and symbol in all confidential information is encrypted in (e.g., via an RC4 encryption method) and the key to begin the process is not known to any one individual. Prospective customers are contacted by the website and offered the opportunity to receive product and vendor satisfaction information, and to take part in the sales process, prior to the sales lead being distributed to a vendor registered with the website. A prospective customer is directed to their own unique project on the website. Advertisers are able to present product-specific advertising directly at, and only at class “A” prospects with the expressed intent to purchase any product or service, and before vendors of that product even know that they are “in the market.”

Note that a class “A” prospect is someone who (1) has an immediate need for a particular product or service, (2) can afford a particular product or service, and (3) has the authority to say “yes” to the purchase a particular product or service. This process actually includes the prospect in the sale before the sales person even knows they are in the market to buy. The successful registered vendor, after completing the sale, pays a finder's fee to the website, which is then shared with the lead source who registered the lead. Finder's fees are agreed upon between the website service provider and the vendors. Lead sources are preferably not privy to this information.

The system and method according to the present invention works as follows. Any individual (lead source) with information that another individual or company (customer) is contemplating the purchase of any product or service, can anonymously register that information as a sales lead (lead) on the service provider's website. If no one else has already registered that identical lead, then a “project” is created. Upon the completion of a sale, the lead source will earn a finder's fee, providing the sale is completed by a vendor who has received the lead from the service provider.

Lead sources can earn additional commission from one or more down line sources, which are other lead sources brought to the site by the original lead source. Methods are employed to ensure that only the first person to register a particular lead, to the exclusion of others, is able to do so. In one example, a three-tier down line system is employed wherein the original lead source is their own first tier, with override referral fees coming from two additional tiers of members. Lead sources are encouraged to invite their friends and family members to participate and register as a member of their down line. Friends and family members are in turn be encouraged to invite their friends and family members to join as well to form their own down line and so on.

Once a lead has been submitted, it will be presented directly to those registered vendors for that particular product or service category requesting leads from that particular geographic territory. Vendors, upon receiving the lead, will pursue the sales opportunity and will pay the appropriate finder's fee to the service provider and complete and return a lead source satisfaction survey. Upon receipt of the finder's fee payment from the vendor, service provider will then pay the lead source and their “up-line.”

The website is preferably designed to interact with three distinct categories of participants: lead sources, vendors, and customers. The lead sources are people who have “insider” information about the intent of another person or company who is in the market, or about to enter the market, to purchase any product or service, the information of which would be valuable to any vendor who sells that particular product or service. In one example, the lead source and the company are the same person. Vendors are companies or individuals who sell their products or services by means of a direct, inside or outside sales force, dedicated to discovering and making contact with prospective customers for their product or service. The customers are companies or individuals who are actually in the market, or about to enter the market, for a particular product or service that is sold by vendors.

The system and method according to the present invention has several key unique attributes. First is the complete anonymity of the lead source. The service provider does not reveal any lead source information to a vendor or a customer without the lead source's permission. Because anyone can be a lead source, and each lead source remains anonymous to vendors and customers alike, there is no fear of being “discovered.” As a result, literally anyone with access to the internet and the website can participate in sharing in the cost of sales. There is no better sales lead available than one that is produced and reported as soon after a prospect first articulates his/her desire to purchase as possible. A second attribute is the ongoing income potential for the lead source. All finder's fees are shared with the lead source. Every Lead generated can earn a finder's fee that is paid directly to registered lead source through the website. As a result, a significant income can be earned by anyone.

Additionally, if the prospect registers his own project as a lead, then the final cost of the product or service to them is further reduced. A third attribute is that a multi-tiered down line is available so lead sources can dramatically increase their extra income through the efforts of others. Since a lead source can sign up friends and families as lead sources as well, they can earn a portion of their down line's finder's fees as well, significantly increasing their extra income. A fourth attribute is the willing participation of the prospective customer before the vendors are even aware that a sales lead has been created. Customers are invited and encouraged to take part in the process before the lead is forwarded to vendors. This allows the customer to have some control over who calls on them and when, and even presents them with valuable vendor and product satisfaction reports on the very vendors they are about to hear from.

A fifth attribute is additional information made available to the customers. With the customers' participation, an entire new market is opened by the service provider. In one example, products such as vendor satisfaction and product satisfaction reports are offered for purchase by the customer before selected vendors are even notified that the lead exists. In another example, vendor satisfaction and product satisfaction reports are offered for no cost to the customer as an enticement to take part in their own sales cycle, if this customer has been reported as a current project.

Plus other timely business-to-business services are offered that further enhance the customer's purchasing experience and help them become a more informed customer. Some of these business-to-business sales services can include: product video presentations by vendors and full motion, real-time video conference presentations, vendor-to-prospect and vendor-to-lead source chat and email integration, etc. A sixth attribute is vendor membership levels through which Vendors are provided with information in additional to the initial Lead. The additional information can be, for example, up-to-date sales process information, including competitor's progress and customer's responses the vendor has enrolled in an appropriate membership level.

Although there are preferably vendor membership levels that can be purchased based on additional services offered, there preferably is no charge to a vendor for a basic Level I membership to receive leads. The finder's fee amount is preferably determined completely by the individual Vendor and is declared at the time of initial registration with the website and upon completion of the vendor profile. If a vendor has purposely avoided paying the agreed upon finder's fee, that vendor is preferably barred from participating and receiving leads in the future. Lead sources that provide bogus or false leads will be barred from participating in website services in the future.

The service provided has several revenue sources. First, a portion of all finder's fees paid by vendors are retained by the service provider before Lead Sources are paid. Second, vendors pay membership dues to the service provider for membership levels having enhanced services such as, for example, Level II, III, IV, and V Vendor membership dues. Vendors receive differentiated levels of enhanced services that correspond to their membership level. Third, manufacturers pay the service provider for advertising directly to prospective customers on the customer project pages of the website. Fourth, debit/gift card vendors (Lowe's, Home Depot, Barnes & Noble, etc.) pay the service provider for advertising directly to lead sources on the lead source member pages as they choose how they want to receive their finder's fee and down line payments. Fifth, the service provider receives payments for general advertising directly to vendors by vertical, vendor-specific advertisers. Sixth, the service provider receives revenue from the direct sale of product satisfaction reports and vendor satisfaction reports to customers who have been registered by lead sources. Additionally, the vendors pay the service provider for pre-presentation video presentations from vendors to customers, full product presentations from vendors to customers, and live, full motion video conferencing presentations between vendors and customers.

It is also apparent from the foregoing disclosure that the system and method of the present invention addresses the enormity of the prospecting step of the sales cycle which is the most expensive and most difficult step to master and manage. By directly “tapping” into the intent of a buyer and gathering the critical information about the prospect early, much of the expense and challenge of prospecting is eliminated. The system and method of the present invention also provides valuable and never-before-available information specifically about class “A” prospects. Additionally, attractive incentives and encouragement are provided for lead sources to discover how best to make the approach as well as some of the prime buying motives that will be critical at the time of closing.

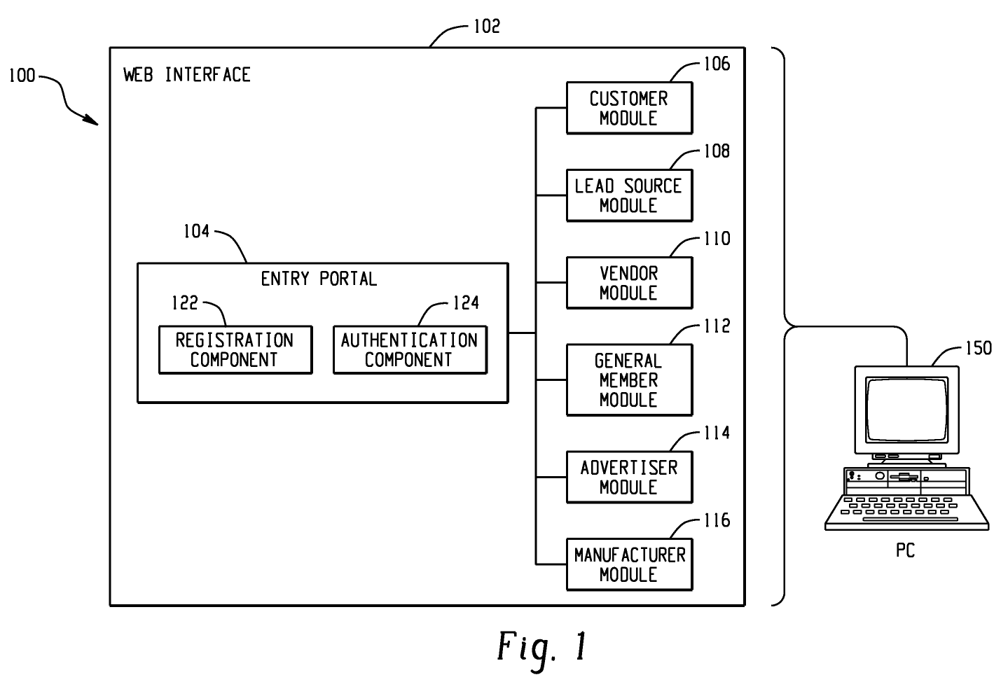

FIG. 1 illustrates a system 100 that facilitates interaction of a lead source with a vendor in order to facilitate a sales transaction. In this manner, prospects who are unaware of vendors selling a particular product and vendors unaware of prospects requiring such a product can be brought together to engage in a sales transaction. The system 100 includes a web interface 102 that allows a user to access the system over a network. In one example, the web interface 102 is accessible via a wide area network, local area network, and/or the Internet via a wireless or wired connection.

The web interface 102 includes an entry portal 104 that allows a user to access the information related to a party with a service/good requirement (e.g., a prospect) and a service/good provider (e.g., a vendor). The entry portal 104 also allows a lead source to provide information that is specific to one or more prospects. The information can identify the name of the prospect (ABC Company), the good and/or service sought (widgets), and a contact that has authority to make such a purchase (CEO Jeff Smith). The lead source can also include information such as a deadline for resolution of the need, budget restrictions, and whether the lead source can be identified to the prospect, for example. In this manner, the system 100 can allow a vendor and a prospect, which may be previously unknown to one another, to interface based on a sales lead to determine if a transaction can be complete. If so, the prospect becomes a customer of the vendor.

The entry portal includes a registration component 122 and an authentication component 124. The registration component 122 allows a user that is new to the system 100 to create an account in order to interface with other members. The authentication component 124 allows existing users to enter the system via one or more authentication algorithms (e.g., a username and password). For each user type, a particular module can be employed to utilize the entry portal 104 to access the web interface 102. It is to be appreciated that although six user types are specified, a plurality of disparate user types apparent to one skilled in the art can be employed. For exemplary purposes, a user can be categorized as a customer, a lead source, a vendor, a general member, an advertiser, and/or a manufacturer. Each user in turn can interface with the system 100 via one of six modules, namely, a customer module 106, a lead source module 108, a vendor module 110, a general member module 112, an advertiser module 114, and a manufacturer module 116. In this manner, a user is identified for participation with the system 100 that is pertinent to their specific user type.

The system 100 can track and manage information provided by a lead source. This lead source information is delivered to one or more qualified vendors that meet a predetermined set of criteria. For instance, the vendor must have the same category of goods and location as the prospect. If a sales transaction occurs, the lead source is compensated. In one example, the lead source is paid a predetermined percentage of the total amount of the sales transaction. In another example, the user is paid a flat fee for the information provided via the sales lead.

Alternatively or in addition, the lead source can be barred from receiving certain information related to the sales transaction between the vendor and the customer. This limitation of information dissemination can deter the system 100 from facilitating bidding wars between vendors when sales transaction volume is known to the membership of the system 100. Further, this restriction can allow a lead source to feel comfortable in providing information related to a particular requirement without allowing other members from otherwise unfairly capitalizing on the information provided by the lead source.

The customer module 106 permits a prospect to interface with one or more vendors prior to completion of a sales transaction therewith. In one example, the customer is notified, via email or other means, that a lead source has provided information to the system 100. This notification allows a customer to interface with one or more vendors to provide additional details related to their particular requirement. This early interaction between the customer and the vendor can allow a vendor to more particularly satisfy customer need and further allow optimum pricing to be realized as a vendor knows more explicit details of the customer's requirements. In one embodiment, the customer can interface with one or more vendors and/or a lead source via an instant messaging platform or the like.

The lead source module 108 allows a user to anonymously add a lead to the system 100 or to view and/or modify active leads that have been previously entered. In order to maintain anonymity, at least one of a name, an address, an IP address, a phone number, a facsimile number, and an email related to the lead source is not revealed to any disparate party within the system 100. In addition, the lead source module 108 can allow a user to view account information such as customer ratings, downline management of additional lead sources, a scorecard, personal information, and/or compensation earned for participation in the system 100. When entering a new lead, a user can provide basic information such as: a prospect name (e.g., company name if commercial or individual name if residential), a street address, a phone number and the good or service required. The basic information can be designated as Block A.

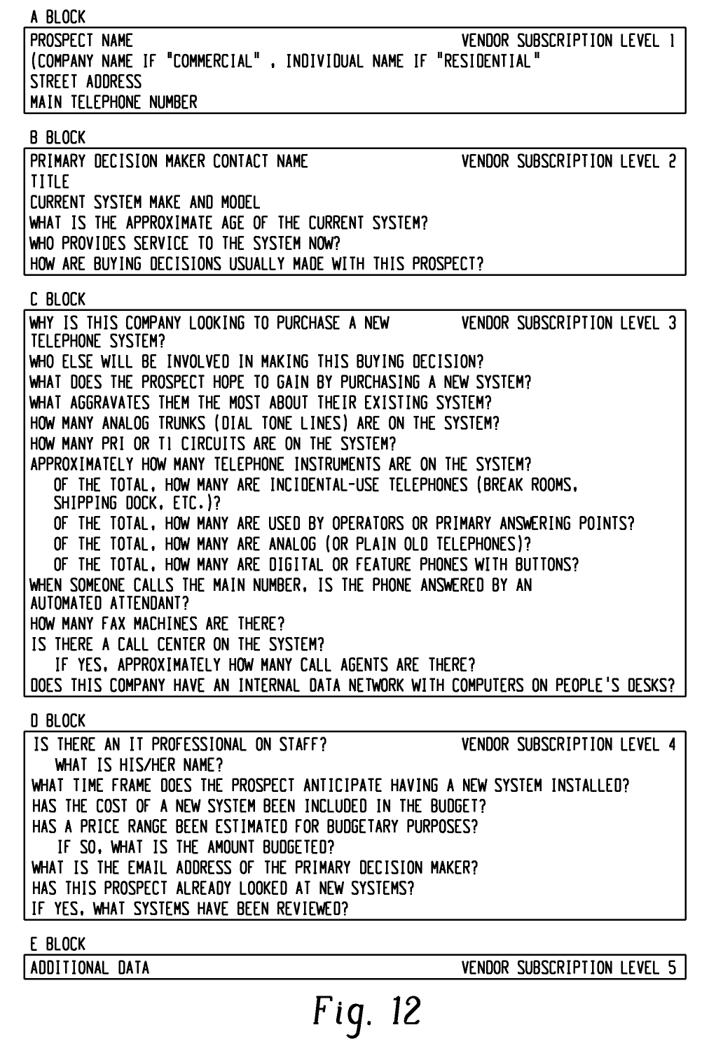

Additional information groupings that enhance Block A information can be designated as Block B, Block C, Block D, etc. These blocks can include a primary decision maker, a title, and a current make/model of a product, for example. A tiered structure can allow information to be packaged into blocks available to access by disparate users. In one example, each information block is associated with a cost in addition to the basic information. It is to be appreciated that the information provided can vary from business to business or location to location. A form containing a plurality of information groupings for an exemplary business is provided herein at FIG. 12.

In order to create lead, a user need only enter information needed to satisfy block A. In turn, the system 100 can evaluate whether such information has been previously provided to the system 100 and notify the user of the same. Either the user or a system administrator can assign a category for the good/service required in each lead. In one example, the good required is an automobile and is placed into a vehicle category. The category structure is consistent for lead sources and vendors to insure appropriate pairing of lead sources with vendors. Thus any vendors that are enrolled in the vehicle category and in the appropriate zone will receive this lead.

A project is created for access and review by the lead source, the appropriate vendors and the prospect (potential customer) referenced in the lead source. Creation of a project requires 1) block A information and 2) a category assigned thereto. Once a project is created, an email or other communication can be provided to the customer specified in the lead (e.g., via the customer module 106) to invite them to participate in the sales process. The customer in turn can provide more specific details related to the job requirement such as: budget constraints, product preferences and information to provide optimum times/methods of contact.

For active leads, the user can view a list of the information provided and whether or not such information has lead to the consummation of one or more sales between a system 100 vendor and a customer. If so, a compensation associated with each can be viewed. Compensation paid to the lead source can vary at least in part upon the quantity and quality of the information provided.

One aspect of the lead source module 108 is to maintain the anonymity of the source of information for the lead. Thus, when third parties within the system 100 view the lead, the user associated therewith will not be displayed. The lead will contain only information related to the prospect. By maintaining unidentified sources, users are encouraged to provide more detailed and candid information to the system 100. This is especially true in cases where the user is unauthorized to communicate information related to a potential sales event, wherein a lead source may not have authority to speak on behalf of a company to provide such information.

Another aspect of the lead source module 108 allows a user to invite one or more disparate individuals to provide specific information of which they are aware to the system 100. In this aspect, the user that originated email communication to the one or more users can receive credit for any leads created by their downline contacts that lead to the closure of a sales transaction between a vendor and a customer. It is to be appreciated that a user can be compensated based on the information they provide as long as one of the vendors associated with the system 100 is utilized by a customer. It is not necessary, however, that the customer is enrolled in the system 100 for such compensation to occur.

The vendor module 110 lets a user register with the system 100 as a party that sells goods and/or services. The user can also specify one or more categories that relate to such goods and services. The vendor module 110 can request information from the user to initialize an account with the system 100. This information can include a company name, a contact, a phone number, a facsimile number, a mailing address, an email address, etc. This information can be compared to existing member data to ascertain whether a new account should be created. If, for example, an account with an identical email address has been created previously, the vendor module can send a message to the user to utilize the authentication component 124 to access the system 100. If the contact information does not exist in association with the system 100, the user can enter additional information, accept a member agreement, create an ID, etc. to facilitate creation of a new user account.

The vendor module 110 requires that a user specify one or more zones from which to receive leads. The zones provide granulated information that is related to one or more parameters such as a geographic location (zip code, area code, time zone, state, county, etc.). In this manner, the vendor can focus resources to accommodate a predetermined market segment of their choosing. The vendor can also select zones that they have not yet entered to evaluate whether market entry is warranted in the future. The vendor module 110 also allows a user to monitor current customers to insure they are satisfied with the goods and/or services they are receiving. A current customer listed in a lead source can be an indication that the customer is looking for an alternate source for such good and/or services.

The general member module 112 is utilized to categorize a user to insure they interface with members of the system 100 to a maximum benefit. In one example, the general number module 112 invites a user to become one of a lead source, a vendor and a customer in order to interact with other members of the system 100. If the user wishes to become a lead source, the system 100 can notify the user of the requirements related thereto. In one example, the user can be required to have particular payment methodologies, legal documents, tax documents, etc. in order to qualify as a lead source with the system 100. If the user wishes to become a vendor, the system 100 can request information related thereto such as an employer ID number, a category related to goods and services sold, zones, contractual arrangements, etc. If the user wishes to become a customer, the system 100 can provide lead source and/or vendor information to the customer in order to allow participation for a mutually beneficial relationship between the customer and the vendor based upon the information provided by the lead source.

The advertiser module 114 allows advertisers to establish an account with the system 100 in order to display specific messaging that is relevant to potential sales transactions between a vendor and a customer. In one example, the advertiser's messaging is displayed alongside the vendor when viewed by a prospect. Such ad messaging can be related to goods and/or services that complement those provided by the vendor to allow a customer to enhance or amend their requirements for a particular sales transaction.

The manufacturer module 116 is utilized by manufacturers to monitor sales transactions and/or lead source information to enhance product quality and/or modify product offerings in the marketplace. In this manner, manufacturers can utilize information from members (e.g., lead sources and customers) in a particular market to more adequately serve the prospects therein. The manufacturer module 116 can allow a user to categorize and identify particular keywords and/or other metrics that are requested by customers or provided within a lead source. This information can be organized and packaged to serve as an accessible reference for the manufacturer.

The registration component 122 allows a user to create a new account for access to the system 100. The account information can be specific to a particular user type such as a customer, a lead source, a vendor, an advertiser or a manufacturer. Specific information related to each user type can be entered into preset fields including an email address contact. Once this information is entered, the email address can be checked against email addresses associated with current members to determine if an account already exists with the same contact information. If it is determined that the email address already exists, a notification can be provided to the user and/or the user can be directed to log in using the current email address. In contrast if the email address is not found within the system 100, further information can be gathered from the user. In addition, a member agreement can be presented for acceptance by the user, a user can be created and saved to the system 100 to facilitate subsequent log in by the user.

The authentication component 124 is employed to access the system 100 via a previously created user ID and password. The authentication component can verify the user ID and password are valid and/or that the user ID exists within the system 100. Once the appropriate user name and password have been entered, the authentication component can allow a user to access information specific to their own account and/or to view information related to a lead source vendor, etc. as appropriate. It is to be appreciated that additional verification techniques can be employed to maintain the security of the system 100 from unwanted users.

A computer 150 illustrates one possible hardware configuration to support the systems and methods described herein, including the system 100 above. It is to be appreciated that although a standalone architecture is illustrated, that any suitable computing environment can be employed in accordance with the present embodiments. For example, computing architectures including, but not limited to, stand alone, multiprocessor, distributed, client/server, minicomputer, mainframe, supercomputer, digital and analog can be employed in accordance with the present embodiment.

The computer 150 can include a processing unit (not shown), a system memory (not shown), and a system bus (not shown) that couples various system components including the system memory to the processing unit. The processing unit can be any of various commercially available processors. Dual microprocessors and other multi-processor architectures also can be used as the processing unit.

The system bus can be any of several types of bus structure including a memory bus or memory controller, a peripheral bus, and a local bus using any of a variety of commercially available bus architectures. The computer memory includes read only memory (ROM) and random access memory (RAM). A basic input/output system (BIOS), containing the basic routines that help to transfer information between elements within the computer, such as during start-up, is stored in ROM.

The computer 150 can further include a hard disk drive, a magnetic disk drive, e.g., to read from or write to a removable disk, and an optical disk drive, e.g., for reading a CD-ROM disk or to read from or write to other optical media. The computer 150 typically includes at least some form of computer readable media. Computer readable media can be any available media that can be accessed by the computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other magnetic storage devices, or any other medium which can be used to store the desired information and which can be accessed by the computer.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above can also be included within the scope of computer readable media.

A number of program modules may be stored in the drives and RAM, including an operating system, one or more application programs, other program modules, and program non-interrupt data. The operating system in the computer 150 can be any of a number of commercially available operating systems.

A user may enter commands and information into the computer through a keyboard (not shown) and a pointing device (not shown), such as a mouse. Other input devices (not shown) may include a microphone, an IR remote control, a joystick, a game pad, a satellite dish, a scanner, or the like. These and other input devices are often connected to the processing unit through a serial port interface (not shown) that is coupled to the system bus, but may be connected by other interfaces, such as a parallel port, a game port, a universal serial bus (“USB”), an IR interface, etc.

A monitor, or other type of display device, is also connected to the system bus via an interface, such as a video adapter (not shown). In addition to the monitor, a computer typically includes other peripheral output devices (not shown), such as speakers, printers etc. The monitor can be employed with the computer 150 to present data that is electronically received from one or more disparate sources. For example, the monitor can be an LCD, plasma, CRT, etc. type that presents data electronically. Alternatively or in addition, the monitor can display received data in a hard copy format such as a printer, facsimile, plotter etc. The monitor can present data in any color and can receive data from the computer 150 via any wireless or hard wire protocol and/or standard.

The computer 150 can operate in a networked environment using logical and/or physical connections to one or more remote computers, such as a remote computer(s). The remote computer(s) can be a workstation, a server computer, a router, a personal computer, microprocessor based entertainment appliance, a peer device or other common network node, and typically includes many or all of the elements described relative to the computer. The logical connections depicted include a local area network (LAN) and a wide area network (WAN). Such networking environments are commonplace in offices, enterprise-wide computer networks, intranets and the Internet.

When used in a LAN networking environment, the computer is connected to the local network through a network interface or adapter. When used in a WAN networking environment, the computer typically includes a modem, or is connected to a communications server on the LAN, or has other means for establishing communications over the WAN, such as the Internet. In a networked environment, program modules depicted relative to the computer, or portions thereof, may be stored in the remote memory storage device. It will be appreciated that network connections described herein are exemplary and other means of establishing a communications link between the computers may be used.

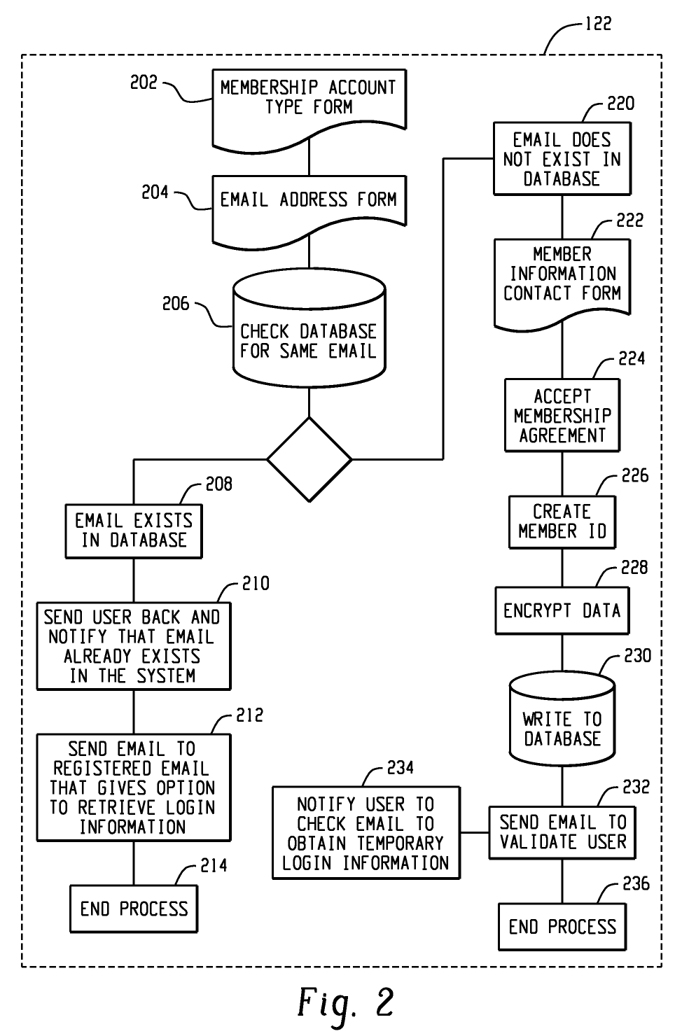

FIG. 2 illustrates the registration component 122. At 202, a membership account type form is presented to a user to gather information related to a particular membership account type. This information can include particular aspects of a user that relate to their role as a member of the system 100. In one example, the user requests membership as a vendor. An employer ID number, a vendor category and/or zones from which to receive lead information can be entered. At 204, a contact email address form is presented to the user to provide one or more email address contacts. At 206, a system 100 database is checked to determine if the email address entered at 204 has been previously entered. At 208, if the email address does exist in the database, a notification is sent to the user that such a condition exists at 210. At 212, an email is sent to the registered email address that allows a user to retrieve log information associated therewith in order to allow the user to access the system 100. At 214 the process ends.

At 220, if the email is not found in the database, a member information contact form is presented at 222. The member information contact form can request information related to the user such as their business name, address, position, etc. It is to be appreciated that the member information contact form can be associated with the member account type form presented at 202, wherein the information requested is particular to the user type. At 224, a membership agreement is presented to the user for acceptance to allow registration with the system 100.

At 226, the user creates a member ID of their choosing, wherein the parameters for ID selection can require specific characters and/or disallow specific characters. At 228, the data entered by the user is encrypted and, at 230, is written to a database. Once the encryption and writing process is complete, the user has successfully created a user ID to access the system 100. At 232, an email is sent to validate the account and, at 234, the user is notified to check the email to obtain temporary log in information. The temporary log in information can be modified once the user has utilized it to access the system 100. At 236, the process ends.

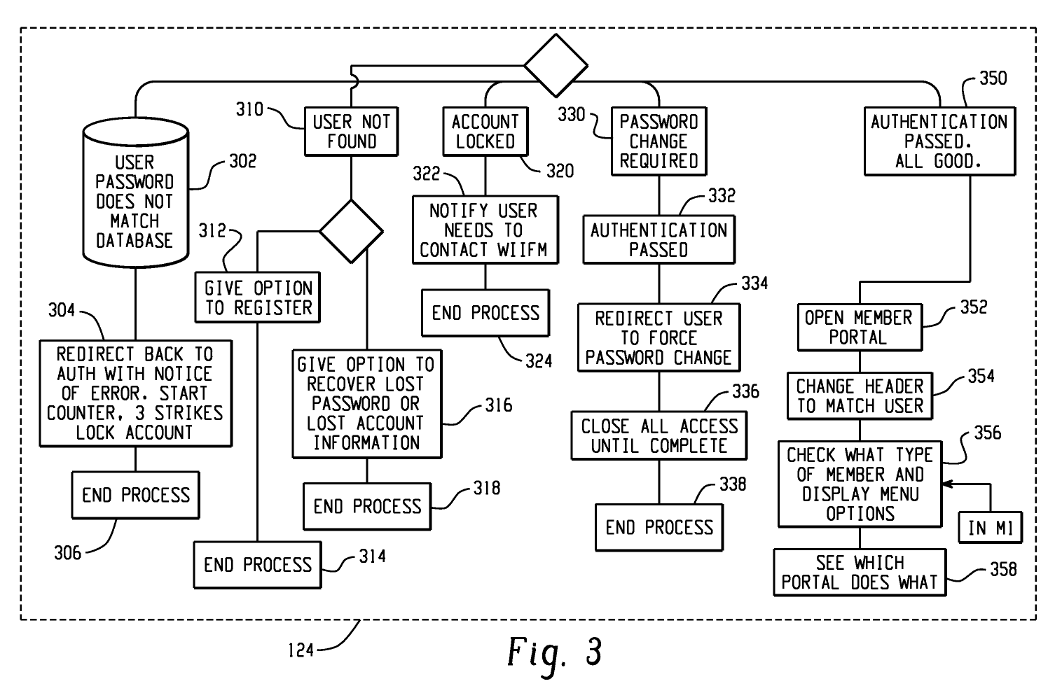

The authentication component 124, illustrated in FIG. 3, is utilized to authenticate users to access the system 100. At 302, once a user and password have been entered, they are verified with existing account information for all users. If the user and password do not match what is stored in the database, at 304, the user is redirected back to the authentication component 124 and a counter is started. The user then has the opportunity to enter their user identification and password two more times before the authentication component 124 locks out the account. At 306, the process ends.

In another scenario, at 310, a user ID is not found in the database. At 312, a user is given the option to register their account wherein the process ends at 314. In this scenario, the authentication component 124 can redirect the user to the registration component 122 to facilitate registration thereof. At 316, a user is given the option to recover a lost password or lost account information. In one aspect, the user can provide an email address, wherein information relating to authentication (e.g. user ID and/or password) is sent to the user for subsequent use to access the system 100. At 318, the process ends.

If the account is locked for whatever reason (e.g. a user ID has been entered incorrectly three times) at 320, a user is notified that they need to contact a system 100 administrator at 322. At 324 the process ends. A password change can be required by the user at 330 in some instances, such as when a predetermined condition is met. In one example, the predetermined condition is that irregular account access is observed such as access from a plurality of disparate IP addresses. Such access can signal fraudulent or unauthorized use of a particular account. At 332, once the user ID and password have been authenticated, the user is directed to change their password at 334. Until the password change is complete, at 336, all access to the system 100 is closed to the user. At 338 the process ends.

Once authentication has passed, the user can be directed to the system 100 at 350. At 352, a member portal (e.g. the entry portal 104) can be opened wherein access to the system 100 is facilitated. At 354, the appearance of the web interface 102 can be modified to match a user preference so that the presentation of data is consistent with a user preference. At 356, a user can check the type of member account that they are associated with and a display of menu options can be presented to the user. At 358, a user can evaluate information type and information a user may access if they open one or more disparate account types. In one example, the user can review a lead source module, a vendor module, a general member module, etc. Such access can be consistent with the type of account that the user has activated.

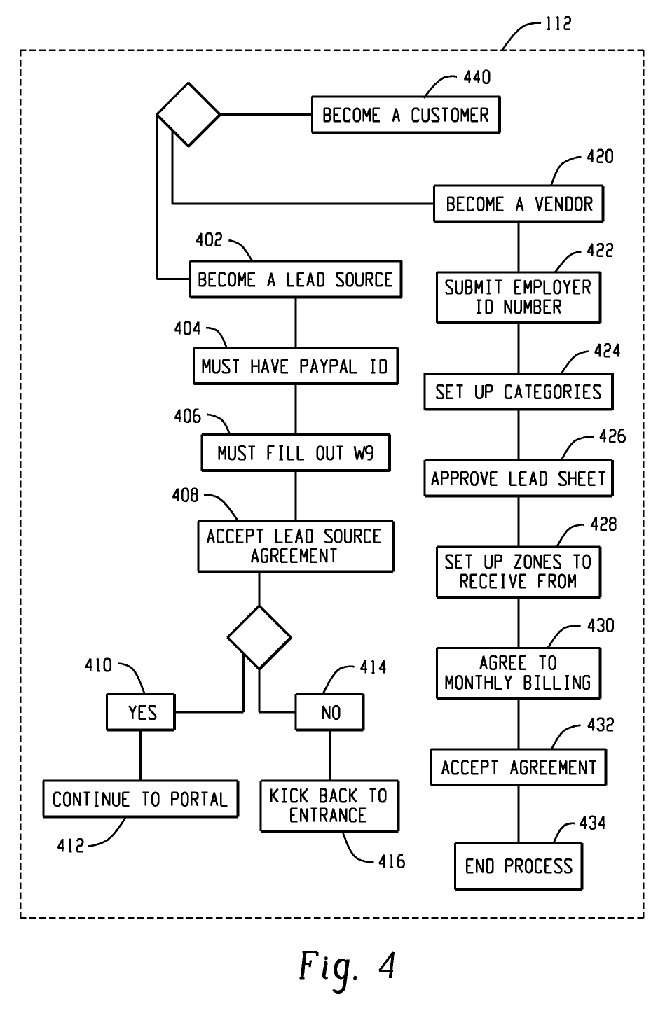

FIG. 4 illustrates the general member module 112 that allows a user to evaluate and select the various member types. For example, a user can evaluate membership opportunities as a lead source, a vendor, and/or a customer. If a user decides to become a lead source, at 402, they are presented with a plurality of requirements to be accepted to the system 100 as a lead source member. At 404, the system 100 requests a pay pal ID from the user. At 406, the user must fill out a W-9 form to be utilized for tax purposes and, at 408, the user must accept a lead source agreement that outlines the terms and conditions of membership to the system 100. If the user accepts such terms, at 410, they are directed to the portal to the lead source module 108. If the user does not accept such terms, at 414, they are redirected back to the general number module 112 to evaluate the membership options once again.

If a user would like to join the system 100 as a vendor member type at 420, they are required to submit a plurality of information associated therewith. At 422, the user is requested to submit an employer ID number which can be related to the state in which the business is incorporated or otherwise in business. At 424, the user can select one or more categories that are associated with the goods and/or services provided by the user that can be sold to one or more perspective customers within the system 100. In this manner, the user can select appropriate categories to insure that the appropriate lead information is directed to the user as a vendor member. Once the categories are selected, at 426, a user approves a lead sheet that contains representative leads within the categories selected.

At 428, the user selects one or more zones to receive such leads that can relate to a predetermined geographic area, such as a zip code, an area code, a state, a county, etc. At 430, the user agrees to a monthly billing plan and, at 432, accepts an agreement that outlines the terms and conditions as a vendor member of the system 100. At 434 the process ends. Another member type is a user may also select a customer member type at 440, which allows a user to participate in a sales process with one or more vendors by providing additional detail associated with the job requirement and/or provide feedback for goods and/or services received from one or more vendors.

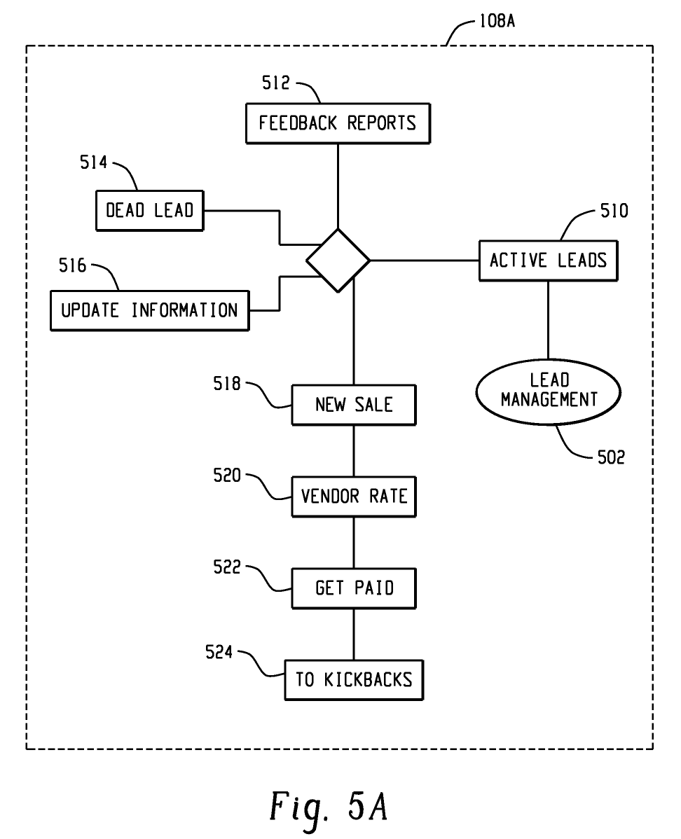

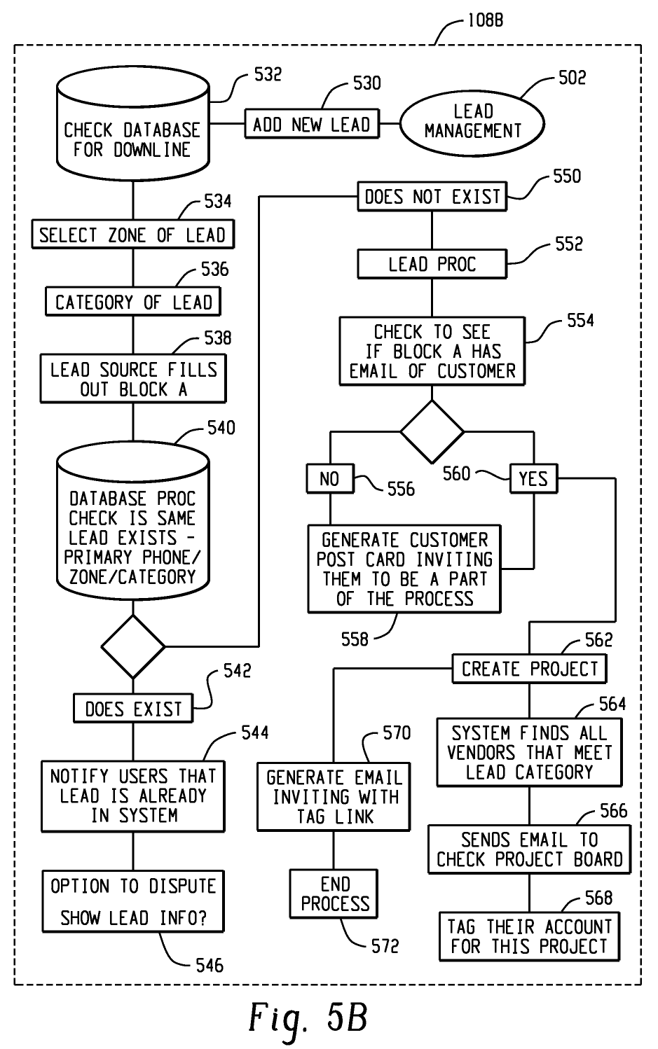

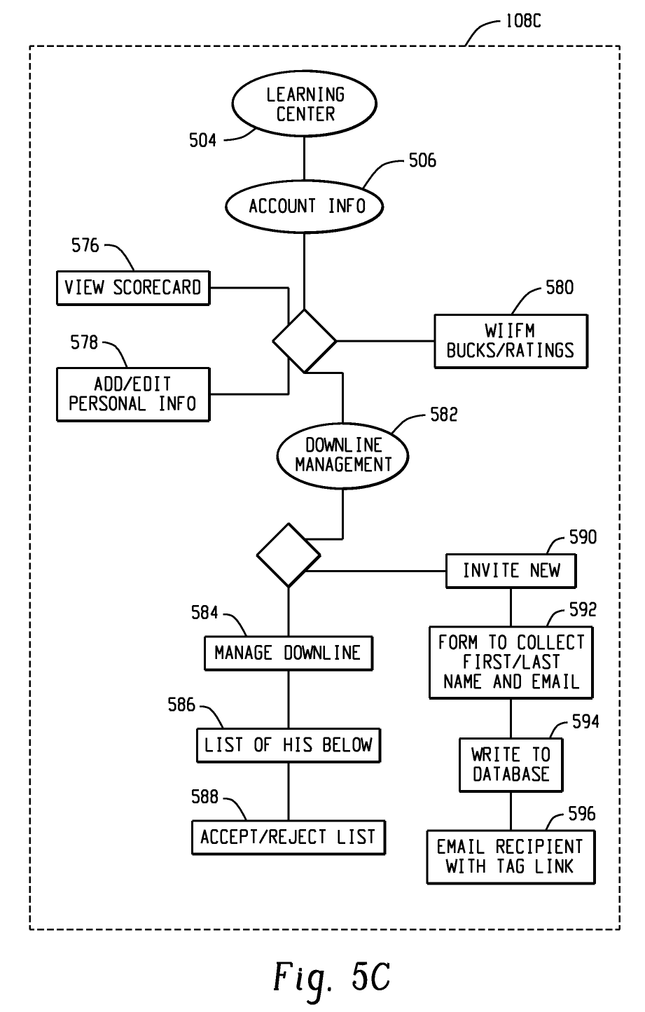

FIGS. 5A, 5B and 5C are directed to aspects 108a, 108b, and 108c respectively of the lead source module 108. In particular, FIG. 5A illustrates a lead management segment for the editing and review of active leads; FIG. 5B allows a user to add a new lead to the lead source module 108; and FIG. 5C allows a user to review information related to their specific account. Turning now to FIG. 5A, which allows a user to select an active lead at 510. The active lead can contain information previously entered that relates to one or more aspects of a potential sale to a customer. If an active lead leads to a sale from a system 100 vendor, feedback can be provided by the customer to which the product and/or service was sold. A summary of the sales transaction can also be provided.

In addition the information provided by the lead source module 108, a lead source can likewise receive feedback from one or more system 100 users. Such information can be accessed via a feedback report at 512. Information can be updated for one or more active leads wherein a dead lead can be designated as such at 514 and an active lead can have information modified therein at 516. In this manner, any lead source information within the system can be kept up to date such that vendors and customers can facilitate transactions in an optimum environment.

At 518, lead source information can lead to a new sale. The vendor rate, specified at 520, is related to the terms of the sale including the amount of goods and/or services sold and the price associated therewith. At 522, a calculation can be made to determine the amount paid to the user that provided the lead source. At 524, a user receives the amount calculated at 522 in the form of a kickback.

Within the lead management segment 108b of the lead source module 108, a new lead can be added by a user at 530. At 532, a database is checked to determine if it the new lead is part of a downline lead provided by another user. At 534, a zone is selected for the lead and, at 536, a category is selected. In this manner, the geographic location and type of lead can be ascertained and indexed for future use. At 538, the user fills out a block of information to further specify the lead source. The lead source information is compared to previously entered lead source information and a database, at 542, to determine if the information has been previously entered. At 542, if the information does exist, a user is notified that the lead is already in the system at 544. At 546, the user is given an option to dispute the redundancy of the information and can provide additional information to support the disparity between the current lead source and one or more disparate lead source previously provided.

At 550, if the lead source does not previously exist, the lead is processed at 552. At 554, a check is made to see if the information block contains the email of the customer specified. If it does at 560, a project is created at 562. The system 100 finds all vendors that meet the lead category, at 564, and sends an email to check a project board at 566. The lead source account is then tagged at 568 for this specific project created. At 570, an email is generated to invite one or more users with a tag link at 570. At 572 the process ends. If the customer email has not been entered at 556, a customer postcard is generated to invite and to be a part of the sales process, whereby they interact with one or more vendors before selection for a given project at 558.

FIG. 5C illustrates a learning center segment 504 and an account information segment 506 of the lead source module 108. The learning center segment 504 can provide information related to methods and practices of obtaining information sufficient to generate a lead and ways of obtaining such information. For the sake of the information provided to the system 100, the learning center 504 can encourage users to garner information from a plurality of disparate resources such as a work place, a home environment, a social environment, etc. to obtain information related to the needs of their friends and colleagues. In this manner, a user can be armed with information related to needs of several different persons or entities that can be employed to generate a plurality of lead sources.

At 506, a user can review account information associated with their lead source module 108. At 576, a user can view a scorecard that relates to the feedback received by one or more vendors and/or one or more customers to provide scoring related to the quality of information provided. Such quality can relate to whether the appropriate contact person was provided, whether correct need and/or deadline was provided, etc. At 578, a user can review and/or edit personal information related to their lead source account. At 580, a reward system can be reviewed wherein a lead source is rewarded for providing particular information related to disparate projects. Such rewards can be given based on the type of lead provided during a certain time period, etc.

At 582, a downline management segment can be employed to invite persons who are not yet members of the system 100 to participate. At 584, a user can manage their downline contacts by reviewing and editing persons invited to participate. At 586, a list can be provided and at 588 a user can review whether or not such invitations have been accepted or rejected by the potential system 100 users. At 590, a user can invite new persons to participate in the system 100. A form can be employed at 592 to collect the first and last name and email address of a potential new member and such information can be written to a database at 594. A potential member can receive an email with a tag link at 596 in order to quickly access an appropriate portal for participation in the system 100.

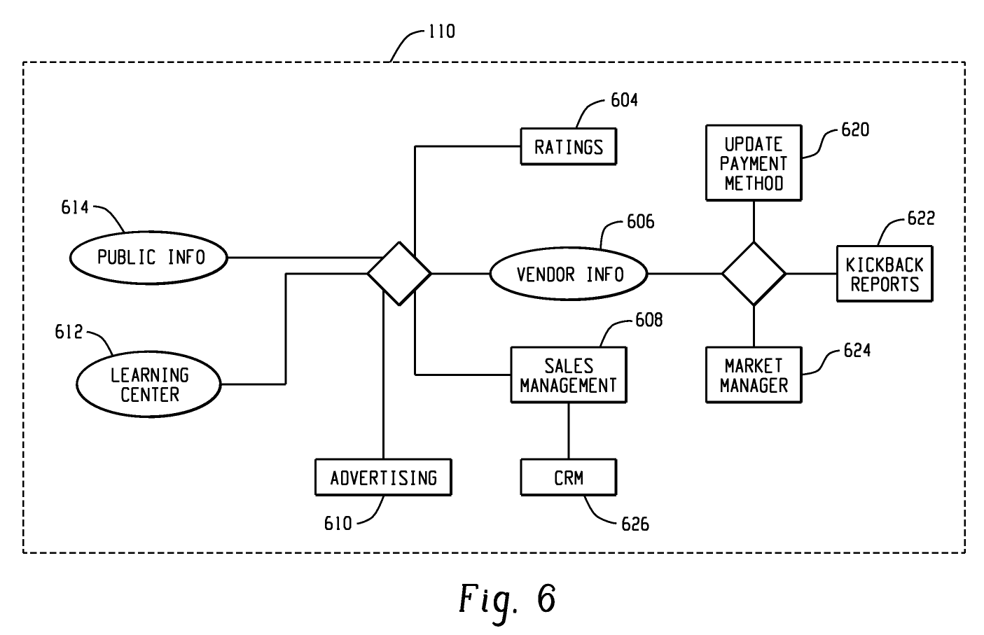

FIG. 6 illustrates the vendor module 110 that allows a user to join the system 100 as a member selling goods or services. At 602, a vendor can review the amount of bucks earned by lead sources that have resulted in a sale between the user and a prospect identified therein. The bucks are earned exclusively by lead sources to encourage lead generation as a reward for positive feedback received from vendors and/or customers that utilized one or more leads provided by the lead source. At 604, a user can review the ratings they have received from other members of the system 100. In one example, the ratings relate to the quality of the goods and/or services provided to one or more customers or to the responsiveness to information provided by a lead source within the system 100. In another example, the vendor can provide ratings to one or more lead sources.

At 606, vendor information can be reviewed and edited. Such information can relate to the method of payment utilized at 620, reports related to kickbacks received from one or more lead sources, at 622, and a market manager, at 624, that allows a vendor to view activity in one or more markets in order to make informed decisions about resource allocation related to potential sales activities. At 608, a sales management tool can be utilized by the vendor to ascertain the level of sales achieved through use of the system 100. At 626, a CRM tool can allow a vendor to maintain appropriate levels of goods and services for customer relationship management. At 610 advertising can be introduced to coincide with goods or services provided by a vendor. In one example the advertising is paid to the vendor as a revenue stream that is shared with the system 100.

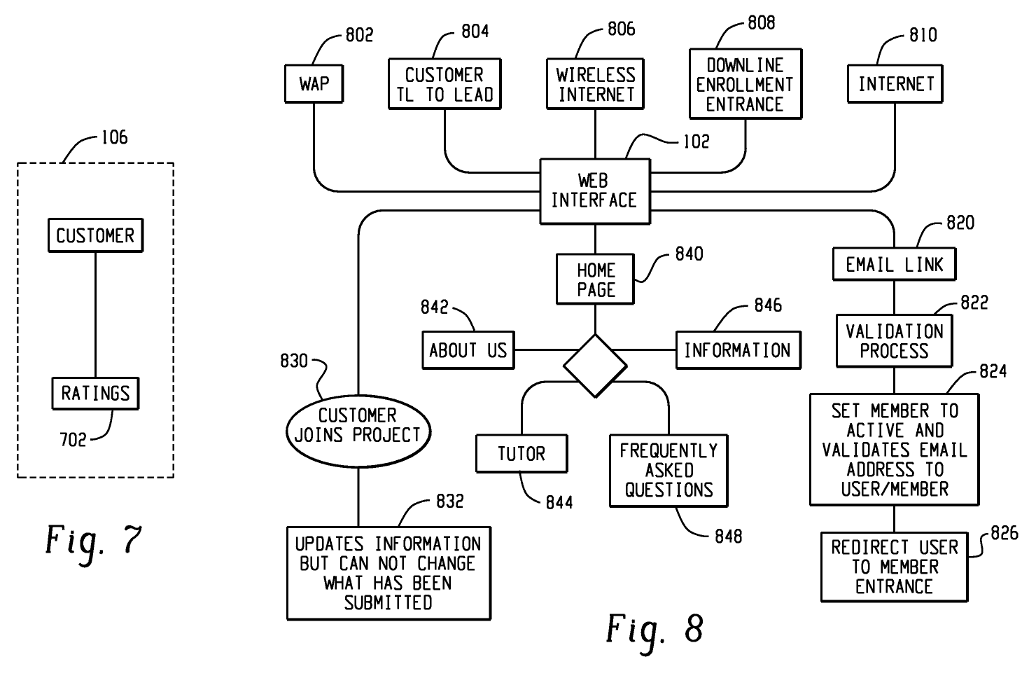

FIG. 7 illustrates the customer module 106. The customer module 106 allows a prospect to interface with one or members of the system 100 to provide additional information and/or feedback related to a sales event. The prospect can communicate with the lead source and/or one or more vendors associated with a particular project. Such information can be provided in a predetermined form such as via one or more blocks of information. Alternatively or in addition, the information can be provided in free-form via a communication tool, such as an instant message platform, etc. In one aspect, the customer module 106 identifies all the projects associated with a prospect to facilitate a user-friendly and intuitive interface. In this way, prospects can be encouraged to participate in the system 100

A ratings module 702 allows a prospect to provide feedback related to vendors and/or the goods and services sold therefrom. In this manner, the prospect can provide information to other members of the system 100 in order to facilitate informed decision making. The ratings can be stored in a common memory store for organization, access and review by others. Vendors can therefore be evaluated on more than price and delivery; they also must live with their reputation developed within the system 100. In this manner, vendors that provide quality goods and/or services can be recognized as a “go to” resource to subsequent prospects.

FIG. 8 illustrates the web interface 102 of the system 100. As indicated, the web interface 102 can be accessed via a variety of means such as a WAP interface 802, a customer tag link to lead 804, a wireless Internet interface 806, via downline enrollment at 808 or via an Internet interface at 810. The interfaces provided are for exemplary purposes only to provide sample means of communication with the web interface 102. It is to be appreciated that the website interface is maintained via the particular computer 150 for execution of code as needed to interact with users.

In addition to the above-referenced interfaces, an email link 820 can be utilized to access the web interface 102. The email link 820 can be emailed to one or more disparate members or non-members of the system 100 for access to the web interface by clicking on a link. In one example, the link is a URL that designates the web interface 102. Once the email link 820 is clicked, a validation process 822 can be utilized to verify that the member utilizing such link is valid. At 824 the member can be set to active and the email address can be validated to that specific member. At 826 the user is redirected to the member entrance within the web interface 102.

The web interface 102 can also include a plurality of information modules that allow a user or member to familiarize themselves with various aspects of the system 100. A home page entrance allows a user to access the various segments of the system 100 such as a lead source, a vendor, a customer, etc. The home page 840 can contain a logo that designates the facilitator of the system 100 as well as various legal notices, contact information, etc. The about us segment 842 can include contact information, including the address and phone number of one or more offices, administrative staff, and leadership of the company of the business facilitating the system 100. The information 846 module can provide supplementary information to the about us module 842 related to the history of the company, markets served, etc.

A tutor module 844 can be utilized by a user to learn about the different aspects of the system 100. In particular, the tutor module 844 can show an exemplary sales event that is facilitated by the presentation of a lead source within a particular category, the presentation of proposals from one or more vendors to a customer specified by the lead source, and the facilitation of an ultimate sales event between the vendor and the customer referred within the lead source. The tutorial can further describe reward systems, downline management and feedback modules utilized to enhance the quality of information exchanged within the system 100.

An FAQ module 848 can provide a knowledge base of information gathered from questions asked by users in the past. The FAQ module 848 can allow a user to review answers to questions that may be similar to their own prior to contacting support personnel. In this manner the user can received satisfactory support in a timely manner by quickly reviewing answers to questions that are frequently asked. At 830, a customer can join a project and communicate with the web interface 102. The customer is able to update information, at 832, provided in a lead but cannot change what has been previously disseminated by the lead source.

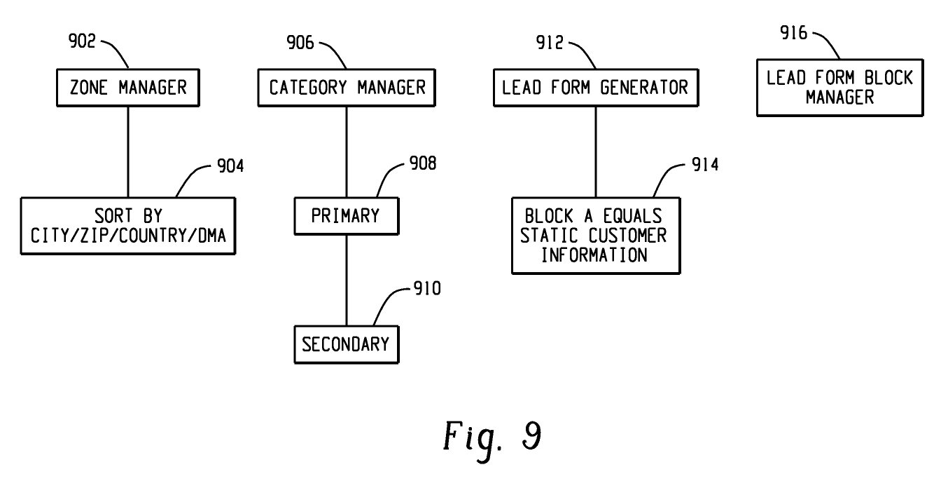

FIG. 9 illustrates additional administrative tools available within the system 100. A zone manager 902 can allow zones to be specified in substantially any granular form. For example each zone can relate to a particular geographic location such as a zip code, an area code, a county, a state, etc. Alternatively, or in addition, zones can be specified by types of goods/services of one or more of the above and/or related to specific locations associated with a particular industry. In this manner, the system 100 can provide zones to users that are relevant and up to date.

A category manager 906 allows disparate categories to be created that are related to particular areas of business. A one or more primary categories can be specified at 908 wherein each of the primary categories is associated with one or more secondary categories at 910. It is to be appreciated that a plurality of levels of categories can be specified beyond a secondary level. Each category can be specific to a particular industry, business type, or related to goods or services sold. The category manager 906 allows categories to be added as needed when disparate business interests are generated by the members of the system 100.

Elite form generator 912 allows information provided by a customer to generate into a lead via the lead source module. At 914, a block of information provided by the customer is mapped to one or more fields in a lead source for use and review by one or more vendors as appropriate. The lead form generator 912 allows a customer to realize a discount as they can be provided with compensation for utilizing a vendor that is a member of the system 100 to complete a sales transaction. A lead form block manager 916 can allow the fields for a lead form to be modified to request specific information related to a potential sales transaction.

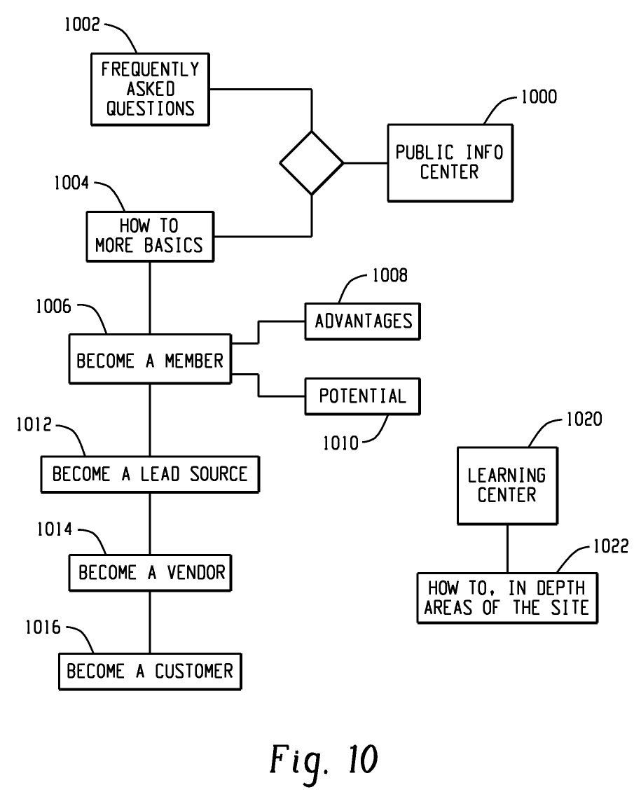

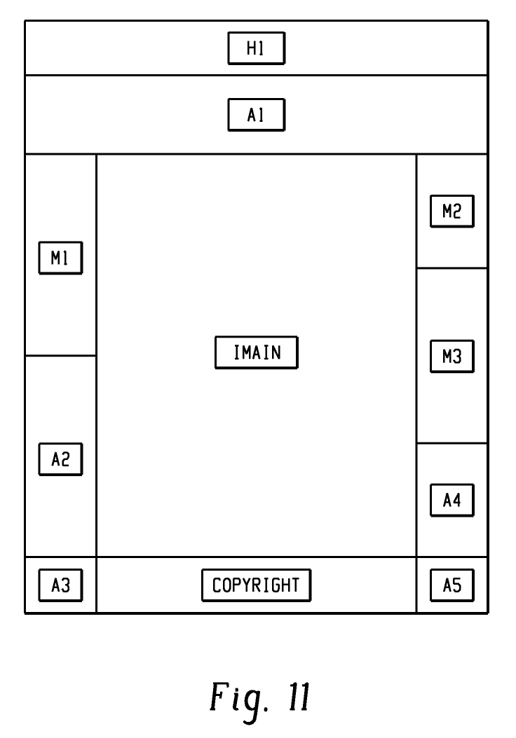

FIG. 10 illustrates a public information center and a learning center. A public information center 1000 is related to frequently asked questions module 1002 and a how to more basics module 1004 in addition to the tutor module 844 and the FAQ module 848. A user can discern how to become a member at 1006 and the advantages at 1008 and potential income realized at 1010 associated therewith. At 1012, a user can learn how to become a lead source and how to become a vendor at 1014 and a customer at 1016. By providing this information to potential members, users can reap the full benefit of the use of the system 100. The learning center 1020 allows administrators to edit the content associated with information provided to users that interface with the system 100. At 1022 a module can be utilized to utilize and expound on various aspects of the information provided to users visiting the web interface 102.

FIG. 11 illustrates an exemplary web interface 102 that can contain a plurality of fields in particular locations. A header H1 can contain a logo or other information related to the system owner or facilitator. Areas A1, A2, A3, A4 and A5 designate exemplary locations for advertising space within the web interface 102. Areas M1, M2, and M3 designate displays that are member specific. That is, they relate to a member type and information associated therewith. IMAIN displays content provided by the system 100 to the web interface 102.

It will be appreciated that several of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer program embodied on a computer readable medium that creates a web interface to facilitate a sales transaction between a vendor and a customer via a sales lead system, comprising:
a web interface source code segment that facilitates the presentation of content to a user that accesses the web interface and allows the reception of data provided by the user to interface with the sales lead system;
a lead source module that allows a lead source to add lead information to the sales lead system, the lead source module is configured to receive lead source information related to an imminent purchase of at least one of a good and a service by a prospect, and a name of the prospect; and
a vendor module that allows one or more vendors to access one or more leads and/or interface with the prospect to receive additional information related to the lead, wherein the one or more vendors are not provided with information to identify the lead source.

2. The computer program as set forth in claim 1, wherein information to identify the lead source includes at least one of a name, an address, an IP address, a phone number, a facsimile number, and an email related to the lead source.

3. The computer program as set forth in claim 1, wherein the lead source receives a kickback when a sales transaction is consummated between the prospect and at least one of the one or more vendors, the kickback is at least one of a flat rate fee, a percentage of the sales transaction, and a reward point.

4. The computer program as set forth in claim 1, wherein the lead source module receives a basic block of lead source information that includes a business name, a business address, and a telephone number.

5. The computer program as set forth in claim 4, wherein the lead source module receives an enhanced block of lead source information that includes a business contact name, an email address, a facsimile number, a permission for the identity of the lead source to be provided to the vendor to provide to the prospect, a budget constraint, a time constraint, a business contact title, a preferred contact time, and one or more preferred contact numbers.

6. The computer program as set forth in claim 4, wherein at least one of the lead source and the sales lead system specifies at least one category to define the goods and/or services to be purchased by the prospect, and at least one of the vendor and the sales lead system specifies at least one category associated with the vendor.

7. The computer program as set forth in claim 4, wherein a project is created once the basic block of information for the lead and the category of the lead is received by the system, wherein projects received subsequently that are identical are rejected by the system.

8. The computer program as set forth in claim 7, wherein a lead is only provided to the vendor when at least one category of the lead matches at least one category associated with the vendor.

9. The computer program as set forth in claim 1, wherein the amount of the sales transaction is not provided to the lead source.

10. The computer program as set forth in claim 1, wherein each of the one or more vendors specifies at least one zone from which to receive leads, each zone relates to at least one of a zip code, an area code, a city, a county, a state and a country.

11. A computer implemented method to facilitate a sales transaction between a vendor and a customer via a sales lead system, comprising:
receiving a lead from an anonymous lead source via an interface coupled to a network, the lead is related to an imminent purchase of at least one of a good and a service by a prospect, and a name of the prospect;
receiving information related to one or more vendors via the interface coupled to the network, the one or more vendors sell goods and/or services, wherein the one or more vendors are able to interface with the prospect to receive additional information related to the lead;
matching the lead to at least one of the vendors via a server coupled to the network;
identifying a sales transaction consummated between the at least one vendor and the prospect; and
delivering a kickback to the lead source based at least in part upon the consummation of the sales transaction.

12. The method as set forth in claim 11, wherein the prospect communicates with at least one of the one or more vendors and/or the lead source via an instant messaging platform.

13. The method as set forth in claim 11, wherein the prospect and the vendor can provide feedback related to the quality of information from a particular lead source.

14. The method as set forth in claim 11, wherein advertising can be presented via the web interface to a user that is related to at least one of goods and services sold by a vendor and/or the good and/or services purchased by a prospect.

15. The method as set forth in claim 11, wherein the lead source is kept anonymous by not identifying at least one of a name, an address, an IP address, a phone number, a facsimile number, and an email related to the lead source.

16. The method as set forth in claim 11, wherein the kickback is at least one of a flat rate fee, a percentage of the sales transaction, and a reward point.

17. The method as set forth in claim 11, wherein the lead source provides at least one of 1) a basic block of lead source information that includes a business name, a business address, and a telephone number and 2) an enhanced block of lead source information that includes a business contact name, an email address, a facsimile number, a permission for the identity of the lead source to be provided to the prospect via the one or more vendors, a budget constraint, a time constraint, a business contact title, a preferred contact time, and one or more preferred contact numbers.

18. The method as set forth in claim 11, wherein the vendor pays a first fee to view the basic block of lead source information and a second fee to view the enhanced block of information.

19. The method as set forth in claim 11, wherein at least one of the lead source and the sales lead system specifies at least one category to define the goods and/or services to be purchased by the prospect, and at least one of the vendor and the sales lead system specifies at least one category associated with the vendor.

20. The method as set forth in claim 11, wherein each of the one or more vendors specifies at least one zone from which to receive leads, each zone relates to at least one of a zip code, an area code, a city, a county, a state and a country.
